(19) United States
(12) Patent Application Publication
(10) Pub. No.: US 2026/0182534 A1
(43) Pub. Date: Jul. 2, 2026

(54) A FLOORING SYSTEM ADAPTED TO BE FIXED OVER A SLATTED FLOOR IN AN ANIMAL HOUSING ENCLOSURE

(71) Applicant: GROUP ELASTOTECK, MOUZEIL (FR)

(72) Inventor: Jean-Vincent BIORET, PETIT-MARS (FR)

(21) Appl. No.: 19/421,933

(22) Filed: Dec. 16, 2025

(30) Foreign Application Priority Data
Dec. 27, 2024 (FR) 2415316

(51) Int. Cl. A01K 1/015; A01K 1/01

(52) U.S. Cl. CPC A01K 1/0157; A01K 1/01

(57) ABSTRACT

The present invention relates to a flooring system for a slatted floor in an enclosure for raising animals, the system comprising a flooring and fixing devices (5).

According to the invention, the fixing devices are provided to comprise a head (56) including fixing means (560) that attach to the flooring and a body (51) including locking means (510) capable of being maneuvered between two positions:
an unlocking position, adapted to allow the translation of said body relative to said evacuation duct, and
a locking position, adapted to prevent the translation of said fixing device within said evacuation duct,
   which head includes operating means (561), adapted to the operation of said locking means between said two positions.

### TECHNICAL FIELD OF THE INVENTION

The present invention relates to the technical field of flooring for animal enclosures, for example, cattle enclosures. More specifically, the present invention relates to a flooring system adapted to be fixed over a slatted floor in an animal enclosure.

### STATE OF THE ART

Animal comfort is a determining factor in the performance of a livestock operation, influencing in particular the health, feed intake, fertility and longevity of the animals.

In a stable, this comfort notably implies a rapid and efficient removal of the excrement generated by the animals.

This management of excrement should indeed make it possible to reduce gas emissions and the proliferation of bacteria in the livestock enclosure, and consequently to improve environmental conditions and sanitary performance.

More generally, excessively wet flooring is likely to cause health problems in the feet of animals, including lameness, which constitutes a major health problem in livestock farming.

One solution is to equip animal traffic areas (waiting areas, exercise corridors, etc.) with slatted flooring (generally made of prefabricated concrete slabs), then cover this with a flooring on which the animals'feet rest. This surface improves animal comfort and also helps to reduce floor moisture.

Maintaining the flooring, in relation to the slatted floor, is a key issue.

Indeed, it is necessary to lock the position of the flooring in relation to the slatted floor, in order to allow for proper evacuation of fluids.

The maintaining means must also avoid coming into contact with the animals'hooves, in order to limit their excessive wear and/or avoid injuries.

### PRESENTATION OF THE INVENTION

In order to remedy the aforementioned drawback of the prior art, the present invention proposes a flooring system in which the flooring is associated with fixing devices which are fitted at the level of the evacuation ducts defined in the slatted floor and the flooring, so as to anchor the flooring in a fixed position relative to this slatted floor.

More specifically, the invention proposes a flooring system adapted to be fixed over a slatted floor in an animal housing enclosure, the flooring system comprising:
a flooring intended to cover the slatted floor, advantageously a mat made of an elastomeric material, and
a plurality of fixing devices, designed to secure the flooring to the slatted floor; which flooring comprises:
a lower surface, designed to rest on the slatted floor, and
an opposite upper surface, which flooring includes several slots, intended to come into fluidic communication with at least one opening made in the slatted floor, to define together an evacuation duct adapted to the evacuation of liquids from the upper surface of the flooring.

And, still according to the invention, at least one of the fixing devices comprises:
a body adapted to be inserted in translation into the evacuation duct, from the upper surface of the flooring, and
a head, including fixing means adapted for fixing to the upper surface of the flooring,
   which body includes locking means capable of being operated between two positions:
an unlocking position, adapted to allow the translation of the body relative to the evacuation duct, and
a locking position, adapted to prevent the translation of the fixing device brought into the evacuation duct,
which head includes operation means, adapted to the operation of the locking means between the two positions.

Thus, thanks to the invention, it is possible to fix a flooring onto a slatted floor.

The fixing devices provided for this purpose keep the flooring in a fixed position relative to the slatted floor and prevent the flooring from moving.

The placement of the fixing device within the evacuation duct also ensures a good match between the slots in the flooring and the openings in the slatted floor, guaranteeing good evacuation of fluids.

Furthermore, this arrangement of the fixing devices advantageously reduces possible contact with the animals'hooves.

In addition, the fixing device is easily maneuverable by an operator between the unlocking position and the locking position since the operation means are accessible from the upper surface of the flooring.

Other non-limiting and advantageous characteristics of the product according to the invention, taken individually or in all technically possible combinations, are as follows:
the upper surface of the flooring having several longitudinal grooves adapted to receive the liquids flowing over said upper surface, which longitudinal grooves are intersected by said slots, which means for fixing the head are adapted to be housed in said grooves, advantageously without protruding from said upper surface, preferably, the width dimension of said fixing means is less than the width dimension of said longitudinal groove, and preferably, the longitudinal grooves extend perpendicularly with respect to said slots;
the means for fixing the head include two tabs extending on either side of said body and being adapted to anchor themselves at the level of the upper surface of the flooring, on either side of the slot, where appropriate in the longitudinal groove, which tabs advantageously include at least one hook suitable for penetrating the flooring;
the head of the fixing device has a recess in which the operation means are accessible;
the operation means include a screw comprising a screw head which is accessible from the head of the fixing device, and a screw body which cooperates with said locking means;
the locking means consist of expandable locking means, which locking means are maneuverable between two positions: the unlocking position, defining a first width dimension allowing its movement in translation relative to the evacuation duct, and the locking position, defining a second width dimension, greater than the first width dimension, adapted to prevent its movement in translation relative to the evacuation duct;
the expandable locking means comprise a deformable part comprising two elastically deformable wings, in separation, which extend on either side of a longitudinal axis and define a housing which opens opposite said head; preferably, said housing receives a deforming element which is operative within the housing to adjust the separation of the two wings; preferably again, the wings and/or the deforming element have a flared shape, which deforming element is operative in translation along the housing to define the positions;

The present invention further relates to a fixing device, as such, for a flooring system according to the invention.

This fixing device comprises:
a body adapted to be inserted in translation into said evacuation duct, from the upper surface of said flooring, and
a head, comprising fixing means adapted for fixing on the upper surface of said flooring,
which body comprises locking means suitable for being operated between two positions:
an unlocking position, adapted to allow the translation of said body relative to the evacuation duct, and
a locking position, adapted to prevent the translation of the body relative to the evacuation duct,
which head comprises operating means, adapted for operating said locking means between said two positions.

The present invention further relates to an enclosure for raising animals comprising a slatted floor receiving a flooring system according to the invention.

Finally, the present invention also relates to a method of installing a flooring system according to the invention, the method comprising the following steps:
a step of laying the flooring so as to cover the slatted floor and so that the slots of said flooring are in fluidic communication with at least one opening of the slatted floor to form an evacuation duct,
a step of inserting the fixing device into the evacuation duct, with its locking means in the unlocked position, so as to sandwich the flooring between the head and the slatted floor, and
a step of maneuvering the locking means of the fixing device from said unlocked position to the locked position.

Of course, the different features, variants and embodiments of the invention can be combined with each other in various ways as long as they are not incompatible or mutually exclusive.

### DETAILED DESCRIPTION OF THE INVENTION

Furthermore, various other features of the invention become apparent from the attached description made with reference to the drawings which illustrate non-limiting embodiments of the invention and where:

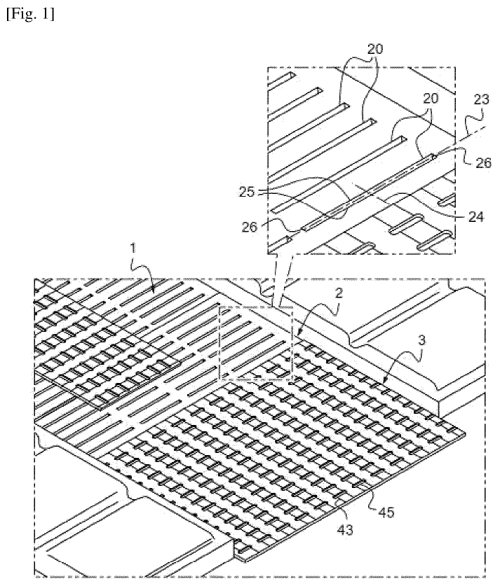

FIG. 1 is a general and perspective view of an enclosure adapted for raising animals according to the invention, having a slatted floor covered with a flooring system comprising a flooring held in place by means of fixing devices;

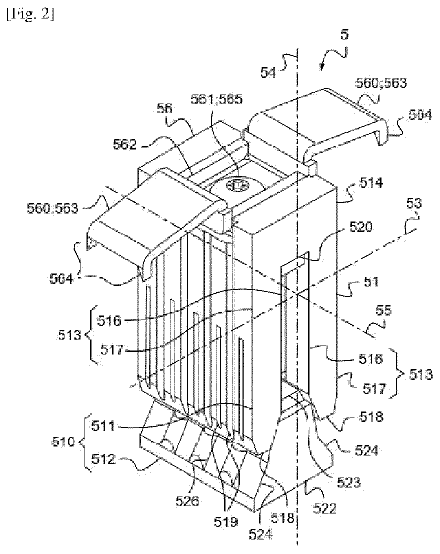

FIG. 2 is an isolated and perspective view of one of the fixing devices, in an unlocked position;

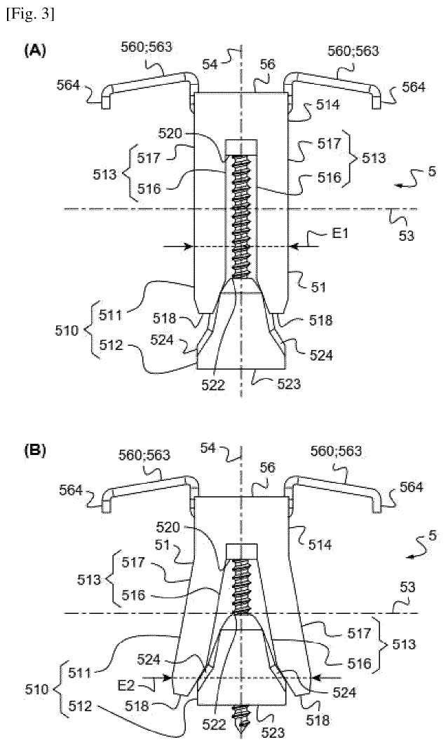

FIG. 3 is an isolated and perspective view of one of the fixing devices of FIG. 1, in an unlocked position (A) and in a locked position (B);

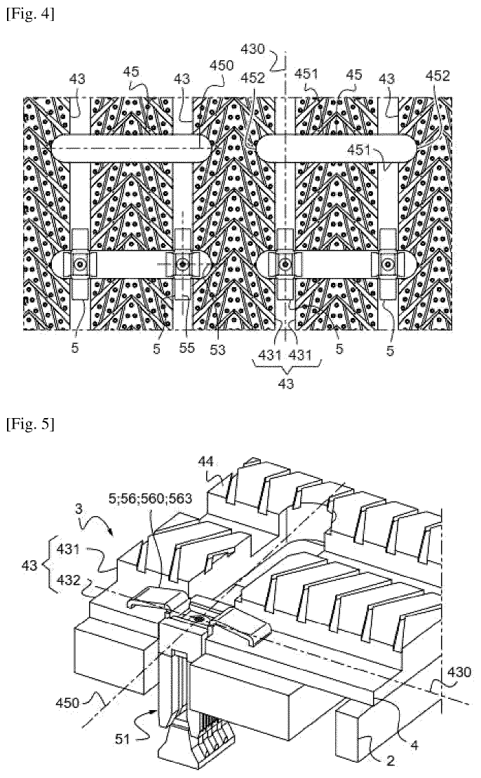

FIG. 4 is a partial top view of the flooring and fixing device of FIG. 1;

FIG. 5 is a perspective view of the flooring system in FIG. 1;

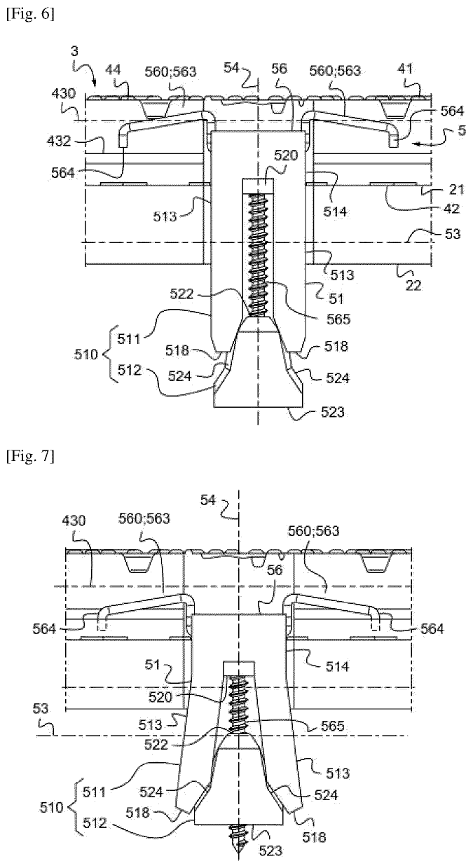

FIG. 6 is a view along a cross-section of the slatted floor covered with the flooring of FIG. 1, with the fixing device in the unlocked position;

FIG. 7 is a view along a cross-section of the slatted floor covered with the flooring of FIG. 1, with the fixing device in the locking position.

It should be noted that, in these figures, the structural and/or functional elements common to the different variants may have the same references.

FIG. 1 schematically represents an enclosure 1 adapted for raising animals.

The term “animals” refers, for example, to cattle (especially dairy cows or beef cattle), pigs, or any other farm animal (sheep, poultry, rabbits, horses, etc.).

This enclosure 1, partially shown in FIG. 1, advantageously consists of a building delimited by a structure (not shown), adapted to the desired livestock farming. For example, in the case of cattle farming, it is a barn.

This enclosure 1 includes a slatted floor 2, for example installed in a circulation area. The circulation area includes, for example, a waiting area, an exercise corridor, a circulation corridor, etc. In this first example, the slatted floor 2 is installed at the level of circulation corridors, used by the animals when they move between the different functional spaces of enclosure 1 (for example, stalls, milking parlors, etc.).

In order to facilitate the evacuation of liquids to the pit below, but also to improve the comfort of the animals by limiting the risk of slips and/or injuries, the present invention proposes a technical solution for covering the slatted floor 2 with a flooring system 3.

In general, this flooring system 3 according to the invention comprises:
a flooring 4 intended to cover the slatted floor 2, and
a plurality of fixing devices 5, intended to secure the flooring 4 to the slatted floor 2.

### Slatted Floor

This slatted floor 2 refers in particular to a floor with openings 20 which lead, for example, to a pit (not shown here).

The dimensions of the openings 20 allow for a compromise between an evacuation of the liquids and animal stability. Here, “liquid” refers specifically to the liquid excrement produced by the farm animals, in particular their urine.

This slatted floor 2 thus forms an openwork floor placed above a pit, which advantageously facilitates the flow and evacuation of liquids.

The slatted floor 2 advantageously comprises two opposite surfaces (FIG. 1):
an upper surface 21 facing the animals, and
a lower surface 22, opposite and oriented towards the pit.

The openings 20 in the slatted floor 2 are through-holes and open through the upper surface 21 and the lower surface 22.

These openings 20, preferably straight, are delimited on the upper surface by a contour. This contour is preferably rectangular or oblong.

Preferably, each opening 20 should have:
a longitudinal axis 23, along which the contour extends lengthwise, and
a transverse axis 24 which is perpendicular to the longitudinal axis 23 and parallel to the upper surface.

Thus, each opening 20 is delimited by:
two long sides 25, the spacing of which defines a width dimension of the opening 20, and
two small sides 26, the spacing of which defines a dimension in length.

The two long sides 25 extend advantageously parallel to the longitudinal axis 23. Advantageously, the two long sides 25 extend parallel to each other.

For example, the openings 20 advantageously have a width dimension of 25 to 42 mm and a length dimension of 2000 to 5000 mm.

Preferably, the openings 20 are regularly distributed across the slatted floor 2, forming a periodic pattern. In particular, the openings 20 are arranged in lines, in which the long sides 25 of the openings 20 are continuous with one another. The slatted floor thus has openings 20 arranged in regularly spaced and parallel lines. Within each line, the openings 20 are, for example, regularly spaced from one another.

In this way, the longitudinal axes 23 of the different openings 20 of the slatted floor 2 are parallel to each other.

Each opening 20 has a depth measured along a vertical axis (not shown). This vertical axis is defined perpendicular to the upper surface 21 of the slatted floor 2. Since each opening 20 is a through opening, the depth of the opening 20 is given by the thickness of the slatted floor 2, measured along this vertical axis.

In practice, the slatted floor 2 is advantageously made up of several slatted slabs (or concrete slats), made for example of concrete.

These slatted slabs advantageously feature a square or rectangular outline, for example:
a width of 500 to 1,200 mm, and
a length of 2,000 to 5,000 mm.

These floor slatted slabs 2 are advantageously juxtaposed, in the direction of the width and/or the length.

In FIG. 1, the slatted floor 2 advantageously constitutes the floor of a passageway which is delimited by two longitudinal edges, defining its width.

### Flooring

Flooring 4 includes:
an upper surface 41, on which the animals come to rest and
a lower surface 42, opposite the upper surface 41.

This lower surface 42 rests on the upper surface 21 of the slatted floor 2.

This flooring 4 is advantageously a mat made of an elastomeric material. The flooring 4 is thus adapted to withstand elastic deformation by indentation when the foot of an animal or person rests upon it. Indentation refers to a decrease in thickness between the upper and lower surfaces of the flooring 4, due to the two surfaces being brought closer together when a vertical force is applied.

For example, flooring 4 is made of natural rubber, “synthetic natural” rubber (or synthetic polyisoprene), or polybutadiene or styrene-butadiene.

Alternatively, flooring 4 is made of a thermoplastic elastomer (TPE) material, namely PVB (Polyvinyl butyral), ABS (acrylonitrile butadiene styrene)/SBR (styrene butadiene), PP (polypropylene)/EPDM (ethylene propylene diene monomer), TPU (polyurethane TPE).

The upper surface 41 of the flooring 4 advantageously includes grooves 43 which are intended to receive liquids flowing over the upper surface (FIGS. 4 and 5). In a possible variant (not shown), the upper surface 41 of the flooring is said to be “flat”, that is to say, it does not have the aforementioned grooves 43.

For example, the grooves 43 are straight and parallel. Preferably, the grooves 43 are equidistant from each other on the upper surface 41 of the flooring 4. Each groove 43 advantageously defines a longitudinal axis 430.

Each groove 43 advantageously has a generally U-shaped cross-section, with a cross-section perpendicular to the longitudinal axis 430, delimited by:
two sides 431, facing each other, for example vertical, and
a bottom 432, for example horizontal.

A distance between the two sides 431 defines a groove width 43.

The distance from the bottom 432, relative to the upper surface 41 of the flooring 4, defines the depth of the groove 43.

For example, each groove 43 has a width ranging from 20 to 30 mm, and a depth of 10 to 50 mm.

Regions between two adjacent grooves 43 are called support strips 44, and advantageously have a width ranging from 100 to 200 mm.

Ideally, these support strips 44 have patterns adapted to facilitate the flow of liquids towards the pit and/or to give anti-slip properties to the flooring 4.

To allow the evacuation of fluids from the flooring 4 to the pit below, this flooring 4 has slots 45. These slots 45 are through slots and open through the upper surface 41 and the lower surface 42 of the flooring 4. These slots 45 are adapted to the passage of liquids flowing over the upper surface 41 of the flooring 4. Thus, these slots 45 advantageously coincide at least partially with the openings 20 of the slatted floor 2 on which the flooring 4 is placed.

The combination of a slot 45 and an aligned opening 20 forms an evacuation duct through which the liquid from the upper surface 41 of the flooring 4 is evacuated. Thus, at least a portion of the slots 45 is in fluidic communication with at least a portion of the openings 20.

These slots 45 are obtained for example by cutting with a water jet in the flooring 4.

According to a preferred embodiment, each slot 45 advantageously comprises a longitudinal axis 450, along which the slot 45 extends lengthwise.

In the embodiment shown in FIGS. 4 and 5, the longitudinal axes 450 of the slots 45 are advantageously perpendicular to the longitudinal axes 430 of the grooves 43.

In practice, each of the slots 45 is then made so as to extend over:
at least part of the width of at least one support strip 44, and
at least part of the width of at least one of the adjacent grooves 43.

In this case, at least one of the slots 45 is designed to extend over:
the width of a first support strip 44, and
at least part of the width of the two adjacent grooves 43 of the first support strip 44, preferably over the entire width of the two adjacent grooves 43.

For example, as shown in FIGS. 1, 4 and 5, the slots 45 of the flooring 4 each intercept two grooves 43.

This slot 45 can still extend over part of the width of the two adjacent (or juxtaposed) support strips 44 of the first support strip.

This slot 45 extends for example over approximately 10 to 30 % of the width of the adjacent support strip 44.

For example, in this embodiment, the slots 45 are arranged on the flooring 4 in a regular pattern. In particular, the pattern formed by the slots 45 on the flooring 4 is designed so that at least part of the slots 45 coincide at least partially with an opening 20 in the slatted floor 2.

For example, the longitudinal axis 450 of a given slot 45 coincides with the longitudinal axis 23 of the opening 20 with which it forms an evacuation duct.

Slot 45 and opening 20 extend lengthwise in the same direction.

Moreover, preferably, the slots 45 each have a contour similar to the contour of the openings 20 of the slatted floor 2.

For example, these contours may be similar in shape. Advantageously, the dimensions of the slots 45 are chosen to reduce the passage through the openings 20 of the slatted floor 2. For example, a section of the slots 45, in width and/or length, is smaller than the section of the openings 20 in width and/or length.

This advantageously generates less gas emissions and is less traumatic for the hooves, thanks to an increase in the bearing surface, and therefore, a decrease in pressure per cm².

Preferably, a dimension in length of the slots 45 is less than the dimension in length of the openings 20 of the slatted floor 2. A dimension in width of the slots 45 is also less than the dimension width of the openings 20 of the slatted floor 2.

In particular, preferably, the slots 45 are intended to be straight, preferably with a rectangular or oblong contour.

This slot contour 45 has two large sides 451 and two small sides 452.

The two long sides 451 define the width dimension of the slot 45. Ideally, these long sides 451 are parallel to the longitudinal axis 450 of the slot 45, and therefore parallel to each other.

The smaller sides 452, for their part, define the length dimension of slot 45.

For example, slots 45 have the following dimensions:
a width ranging from 20 to 40 mm, and
a length ranging from 150 to 250 mm.

The depth of the slots 45 (corresponding to the distance between the upper surface 41 and the lower surface 42) is equal to a thickness of the flooring 41.

As mentioned previously, the slots 45 are regularly distributed across the flooring 4, forming a periodic pattern within the flooring 4. Advantageously, this pattern is similar to the pattern formed by the openings 20 in the slatted floor 2 placed beneath the flooring 4 to facilitate the evacuation of liquids. In particular, the slots 45 are arranged in lines. Within a line, the long sides 451 of the various slots 45 are aligned.

These lines are, for example, regularly spaced and parallel. Within the same line, the slots 45 are, for example, regularly spaced from each other. Advantageously, the lines formed by the slots 45 of the flooring 4 coincide with the lines formed by the openings 20 of the slatted floor 2.

In this way, the longitudinal axes 450 of the different slots 45 of the flooring 4 are parallel to each other.

### Fixing Device

To ensure evacuation of fluids, it is advantageous to keep the slots 45 opposite the openings 20 of the slatted floor 2. For this, the positioning of the flooring 4 must be optimal and its movements relative to the slatted floor 2 must be limited.

It is proposed within the framework of the invention to maintain the flooring 4, over the slatted floor 2, by means of the fixing devices 5. These fixing devices 5 ensure the bonding of the flooring 4 with the slatted floor 2.

These fixing devices 5 are arranged within the flooring 4 and the slatted floor 2 (FIGS. 4 to 8)

According to the invention, the fixing devices 5 each comprise:
a body 51, intended to be inserted into the evacuation duct and to hold the fixing device 5 securely attached to the slatted floor 2, and
a head 56, coming into contact with the flooring 4.

In general, the body 51 includes locking means 510 capable of being maneuvered between two positions:
a first position (FIG. 3A), which corresponds to an unlocking position, in which the body 51 is free to translate along the depth of the evacuation duct, and
a second position (FIG. 3B), which corresponds to a locking position in which the body 51 is locked in translation over the depth of the evacuation duct.

Head 56, for its part, includes:
fixing means 560, suitable for gripping the upper surface 41 of the flooring 4, and
operation means 561, adapted to the operation of the aforementioned locking means 510.

In particular, the body 51 of the fixing device 5 is advantageously parallelepiped in shape.

For example, body 51 is made of an elastically deformable material, in particular chosen from plastic materials.

For example, the locking means 510 consist of expanding locking means 510, operable between the first position and the second position.

Preferably, the locking means 510 are operable between the following two positions;
the unlocking position, defining a first width dimension E1 of the body 51 of the fixing device 5 which allows its movement in translation relative to the evacuation duct, and
the locking position, defining a second width dimension E2 of the body 51 of the fixing device 5, greater than the first width dimension E1, adapted to prevent its movement in translation relative to the evacuation duct.

For this purpose, preferably, the locking means 510 advantageously comprise:
a deformation element 511, advantageously defining the adjustable width dimension, and
a deforming element 512, intended to adjust the width dimension of the deformation element 511.

Preferably, the deformation element 511 comprises two wings 513 fixed to a base 514. Thus, the deformation element 511 has a U-shaped cross-section, notably visible in FIG. 3.

The base 514 cooperates with the head 56 of the fixing device 5. This base 514 advantageously comprises a through hole adapted for the passage of the operating means 561 described later.

For example, the two wings 513 are parallel to each other when no constraints are imposed on them.

And the wings 513 are advantageously adapted to be elastically deformable in spacing, when a deformation force is applied to them, in the direction defined by a first transverse axis 53. This first transverse axis 53 also defines the direction of deformation for the wings 513.

Each of the wings 513 advantageously comprises an inner face 516 oriented towards the other wing 513, and an outer face 517 opposite to the inner face 516.

A housing is defined by a free space between the inner faces 516 of the two wings 513. This housing thus opens opposite the base 514 and the head 56 of the fixing device 5.

A width dimension of the housing is given by a distance between the two internal faces 516 of the two wings 513 along the first transverse axis 53. This housing is configured to accommodate the deforming element 512 described later.

The first transverse axis 53 of the fixing device 5, passing through these opposite faces, is here perpendicular to the wings 513 (FIGS. 2 and 3).

Each wing 513 has a thickness, defined by a dimension between the inner face 516 and the outer face 517.

The distance between the external faces 517 of the wings 513 delimits the width dimension of the body 51 of the fixing device 5 along the first transverse axis 53.

The wings 513 extend lengthwise along a longitudinal axis 54. For example, a wing length 513 (or wing length dimension 513) is measured along the longitudinal axis 54 between the base 514 and a lower end 518 of the wing 513.

In particular, the length of the wing 513 is advantageously provided so that the length dimension of the body 51 is greater than the depth of the evacuation duct (i.e. greater than the sum of the depths of the slot 45 and the opening 20).

A length dimension of the housing is measured between the base 514 and the lower ends 518 of the wings 513.

The lower end 518 of the wings 513, opposite the base 514 and at the level of the inner face 516, here presents a chamfer.

Thus on the inner face, each internal face 516 presents here a first surface parallel to the longitudinal axis 54, extended by a lower chamfer, inclined with respect to the longitudinal axis 54 and moving away in the direction of the external face 517.

Finally, the wings 513 define a second transverse axis 55, perpendicular to the longitudinal axis 54 and to the first transverse axis 53.

Moreover, advantageously, the external faces 517 of the wings 513 have grooves 519.

The external faces 517 thus present a combination of grooves:
deep grooves, extending along the entire length of wing 513, and
superficial grooves, which extend from the lower end 518 of the wings 513, to a midpoint of the wing length 513.

Thanks to this groove system, the fixing device 5 is adapted to allow the proper flow of fluids from the upper surface of the flooring 4, acting like channels. Due to the grooves 519, the wings 513 of the fixing device 5 are also adapted to be elastically deformed under the action of a force.

The deforming element 512, also called “wedge”, advantageously presents a trapezoidal cross-section along the first transverse axis 53.

This wedge has a first end 522 and a second end 523, connected by side walls 524.

The lateral walls 524 are divergent, along the longitudinal axis 53. In other words, these lateral walls move away from each other.

These lateral walls 524 each present here a profile comprising a first surface slightly inclined with respect to the longitudinal axis 54, followed by a second surface more strongly inclined with respect to the longitudinal axis 54.

The deforming element 512 advantageously has the following dimensions:
a first width dimension, taken at the level of the first end 522,
a second width dimension, measured at the level of the second end 523,

The side walls 524 include grooves 526. Advantageously, these grooves 526 are adapted to be aligned in the extension of the deep grooves 519 of the wings 513 of the deformation element 511.

A height of the wedge, along the longitudinal axis 54, is less than the height dimension of the housing.

The deforming element 512 is traversed by a tapped hole (not shown). In particular, the through hole in the base 514 and the tapped hole in the deforming element 512 are aligned and adapted to cooperate with the same screw.

The wedge is held together with the rest of the fixing device 5 by a screw 565, which also forms part of the operating means 561.

This screw 565 is inserted through the through hole in the base 514, and a body 556 of the screw is disposed in the housing between the two wings 513.

One lower end of screw 565 is screwed into the tapped hole by the first end 522 of the wedge.

The head 56 of the fixing device 5 is placed at the top of the body 51, for example, at the level of its base 514.

The head 56 consists for example of an added part, made for example of a metallic material (for example stainless steel) or a plastic material or any other hard and rot-proof material.

According to one embodiment, the head 56 (including the fixing means 560, and in particular the tabs 563) is made as a single piece with the body 51.

Thus, the through hole made on the base 514 also passes through the head 56 of the fixing device 5.

Advantageously, head 56 has a reinforcement 562 that fits within base 514.

This reinforcement 562 is designed to receive the head of the screw 565, in order to limit contact between the animals' hooves and the metal parts. In practice, the head 56 of the screw 565 is countersunk in the recess 562.

This screw head can be operated from the head 56 of the fixing device 5, using a suitable tool.

The head 56 also includes fixing means 560. These take the form of two arms or two tabs 563, placed on either side of the base 514. Viewed from the cross section, the fixing means 560 and the body 51 take the form of a T, of which the body 51 forms the shaft and the two tabs 563, the bar.

In particular, the tabs 563 are arranged here in line with the recess 562. The tabs 563 of the fixing means 560 extend lengthwise along the first transverse axis 53. In other words, these tabs 563 are orthogonal to the wings 513 of the body 51.

Each one of the tabs 563 has a length dimension measured from the base 514 to one end of the tab 563 (opposite the base 514).

A width of the tabs 563 is measured along the second transverse axis 55.

The end of each tab 563 has two hooks 564, adapted to fix into the flooring 4. These hooks 564 take the form of two triangular points.

Each tab 563 advantageously presents a slope, descending towards its end and along the first transverse axis 53.

The tabs 563 thus advantageously define an inverted V, opening towards the body 51, to promote their anchoring in the flooring 4 by elastic deformation.

### Operation of the Fixing Device

As previously stated, the fixing devices 5 are designed to grip the flooring 4 by means of the fixing means 560 in their head 56, and to lock a position of the flooring 4 relative to the slatted floor 2, by remaining attached to the evacuation duct.

For this reason, each fixing device 5 is designed to adopt two positions, or two configurations.

A first position, namely the unlocking position, is shown in FIG. 2 and FIG. 3A.

In this first position, the wedge is located at a distance from base 514.

In the unlocked position, the deforming element 512 is located within the housing between the wings 513. Specifically, the first end 522 of the wedge is inserted into the

housing at the level of the lower ends 518 of the wings. The first width dimension of the wedge is thus advantageously less than the width of the housing. In the unlocked position, the side walls 524 of the deforming element 512 rest against the inner faces 516 of the walls 515 of each wing 513, without exerting any stress on the wings 513.

The first dimension in total width E1 of the body 51 is measured along the first transverse axis 53, between the external faces 517 of the wings 513. In the first position, the wings are advantageously parallel to each other.

The second position of the fixing device 5 is shown in FIG. 3B. This is the locking position of the locking means 510. The transition from one position to the other is made using the operating means 561, that is to say, as it stands, by screwing or unscrewing the screw 565 located on the head 56 of the fixing device 5.

Indeed, the operation of this screw 565, at least partially screwed into the wedge, will translate the deforming element 512 in height and relative to the base 514, between the first position and the second position.

During this translation of the deforming element 512 within the housing, the lateral walls 524 of the wedge exert a deformation force on the internal faces 516 of the wings 513.

These wings 513, under the action of this deformation force, move apart from each other.

In particular, this translational movement of the deforming element 512 along the housing towards the base 514 generates a variation in the width dimension of the body 51. In other words, the width dimension separating the lower ends 518 from the wings 513 increases.

In the second position, i.e. the locking position, the distance between the first end 522 of the deforming element 512 and the bottom 520 of the housing is reduced.

The second width dimension E2 of the body 51 of the fixing device 5 increases in the second position, due to an increase of the spread of the wings.

### Method

The installation of flooring system 3, as described above, is carried out according to a process comprising the following steps:
a step of laying the flooring 4 so as to cover the slatted floor 2 and so that the slots 45 of the flooring 4 are in fluidic communication with at least one opening 20 of the slatted floor 2 to form at least one evacuation duct,
a step of inserting the fixing device 5 into the evacuation duct, with its locking means 510 in the unlocked position, so as to sandwich the flooring 4 between the head 56 and the slatted floor 2, and
a step of maneuvering the locking means 510 of the fixing device 5 from the unlocked position to the locked position.

In particular, the installation step consists of aligning the slots 45 with the openings 20, so as to form evacuation ducts for the flow of liquids towards the pit.

During the insertion step of the fixing devices 5 (FIG. 6), each fixing device 5 is advantageously arranged so that its longitudinal axis 54 is oriented vertically.

For example, it is planned to insert a pair of fixing devices 5 on at least part of the slots 45 of the flooring 4.

In particular, for example, a pair of fixing devices 5 is planned per slot 45 cut into the flooring 4.

Alternatively, it may be decided that within each line, a pair of fixing devices 5 is placed every two slots 45, or every three slots 45, etc.

During this insertion step, the locking means 510 of the fixing device 5 are in the unlocked position.

In this unlocked position, the body 51 of the fixing device 5 has a first width dimension E1 adapted to its insertion according to the depth of the evacuation duct, advantageously without using excessive force and/or tools.

In practice, the wings 513 are inserted within the slot 45, marking an entrance to the evacuation duct.

In particular, during this insertion, the external faces 517 of the wings 513 is oriented towards the long sides 25 of the openings 20 and the long sides 451 of the slots 45.

Furthermore, the head 56 of the fixing devices 5 according to the invention is designed not to protrude from the support strips 44 of the flooring 4, once the body 51 is inserted into a slot 45 (FIGS. 4, 6 and 7).

Advantageously, the fixing means 560 of the head 56 have dimensions in width and height adapted to be housed in the grooves 43 of the flooring 4, without protruding from the support strips 44.

For example, it is provided here that the tabs 563 have a width less than the width of the groove 43. Similarly, it is provided, for example, that the tabs 563 have a height less than the depth of the grooves 43.

The maneuvering step of the locking means 510 allows the fixing devices 5 to be tilted into the locking position (FIG. 7).

Advantageously, the operation of the maneuvering means 561 is facilitated by several aspects of the device presented.

Firstly, the operation means 561, here the screw 565, are easily accessible from the upper surface 41 of the flooring 4.

In addition, the tabs 563 extending across the slot 45 allow the fixing device 5 to be held on the upper surface 41 of the flooring 4.

Finally, the tightening and loosening motion is facilitated for an operator, without the risk of the fixing device 5 rotating. Indeed, the tabs 563 installed in the grooves 43, and the parallelepiped shape of the body 51 inserted into the slot 45 (matching its dimensions), prevent the device from rotating when a tightening or loosening motion is applied to the operating means.

Furthermore, recessing the head 56 of the fixing device 5 into a groove 43 advantageously prevents rotation of the fixing device 5 during its use. The tabs 563, advantageously made of metal to ensure the fixing's strength, are thus set back from the support strips 44. This is advantageous for limiting the risk of injury to the animals.

The screw 565 allows the deforming element 512 to be translated within the housing, so as to progressively separate the wings 513 from each other, as the deforming element 512 approaches the head 56 of the device.

Thus, in the second position, the body 51 of the fixing device 5 advantageously has a second width dimension E2 greater than the width dimension of the slot 45, and by extension, of the evacuation duct. The fixing device 5 is then mechanically locked within the slot 45.

As shown in FIG. 7, in the second position, the outer faces 517 of the wings 513, pushed by the deforming element 512, move apart from each other because they are subjected to a deformation force. This separation of the wings 513 exerts a vertical force on the flooring 4.

In particular, the external faces 517 rest on a lower edge of the opening 20, advantageously at the level of the two long sides 25, so as to exert the vertical force directed towards the pit. This vertical force also drives the hooks 564 of the fixing means 560 into the bottom of the grooves 43 of the flooring 4. The fixing means 560 thus engage with the flooring 4.

Thus, once the fixing device 5 is in its second position, the flooring 4 is sandwiched, that is to say rigidly held between the tabs 563 of the fixing device 5 and the slatted floor 2.

Conversely, the fixing devices 5 according to the invention also have the advantage of being able to be disassembled, for example in the event of replacement of the flooring 4.

The operator simply needs to maneuver the maneuvering means 561 in the opposite direction.

Here again, the operation means 561 are easily accessible from the upper surface 41 of the flooring 4. In addition, the deformation of the tabs 563 being elastic, the fixing devices 5 can be extracted relative to the evacuation ducts.

Of course, various other modifications can be made to the invention within the scope of the attached claims.

1. Flooring system (3) adapted to be fixed over a slatted floor (2) equipping an enclosure (1) for raising animals,
which flooring system (3) comprises:
a flooring (4) intended to cover said slatted floor (2), advantageously a mat made of an elastomeric material, and
a plurality of fixing devices (5), intended to secure said flooring (4) to said slatted floor (2 ), which flooring (4) comprises:
a lower surface (42), intended to bear against said slatted floor (2), and
an opposite upper surface (41),
which flooring (4) comprises several through slots (45), intended to communicate fluidically with at least one opening (20) provided in said slatted floor (2), to define together an evacuation duct adapted for the evacuation of liquids from said upper surface of said flooring (4), wherein at least one of said fixing devices (5) comprises:
a body (51) adapted to be inserted in translation into said evacuation duct, from the upper surface (41) of said flooring (4), and
a head (56), comprising fixing means (560) adapted for fixing to the upper surface (41) of said flooring (4),
which body (51) includes locking means (510) capable of being maneuvered between two positions:
an unlocking position, adapted to allow the translation of said body (51) relative to said discharge conduit, and
a locking position, adapted to prevent the translation of said fixing device (5) placed in said evacuation duct,
which head (56) includes operating means (561), adapted to the operation of said locking means (510) between said two positions.

2. Flooring system (3) according to claim 1, wherein the upper surface of the flooring (4) has several longitudinal grooves (43) adapted to receive liquids flowing over said upper surface (41),
which longitudinal grooves (43) are intersected by said slots (45),
which fixing means (560) of the head (56) are adapted to be housed in said grooves (43), advantageously without protruding from said upper surface (41).

3. Flooring system (3) according to claim 1, wherein the fixing means (560) of the head (56) comprise two tabs (563) extending on either side of said body (51) and adapted to anchor themselves at said upper surface of the flooring (4), on either side of the slot (45), where appropriate in said longitudinal groove (43),
which tabs (563) advantageously comprise at least one hook (564) adapted to penetrate into the flooring (4).

4. Flooring system (3) according claim 1, wherein the head (56) of the fixing device (5) has a recess (562) in which the operating means (561) of the fixing device (5) are accessible.

5. Flooring system (3) according to claim 1, wherein the operating means (561) comprise:
a screw head (565) which is accessible from the head (56) of the fixing device (5), and
a screw body (565) which cooperates with said locking means (510).

6. Flooring system (3) according to claim 1, wherein said locking means (510) consist of expandable locking means (510),
which locking means (510) are operable between said two positions:
said unlocking position, defining a first width dimension (E1) allowing its translational movement relative to said evacuation duct, and
said blocking position, defining a second width dimension (E2), greater than said first width dimension (E1), adapted to prevent its movement in translation relative to said evacuation duct.

7. Flooring system (3) according to claim 6, wherein the expanding locking means (510) comprise a deformation element (511) comprising two wings (513), elastically deformable apart, spreading extending on either side of a longitudinal axis (55) and defining a housing opening opposite said head (56),
which housing receives a deforming element (512) which is maneuverable within said housing to adjust the spacing of said two wings (513) of the deformation element (511).

8. Flooring system (3) according to claim 7, wherein the wing (513) and/or the deforming element (512) have a flared shape,
which deforming element (512) is maneuverable in translation along said housing to define said positions.

9. A fixing device (5) for a flooring system (3) according to claim 1, comprising:
a body (51) adapted to be introduced in translation into said evacuation duct, from the upper surface (41) of said flooring (4), and
a head (56), comprising fixing means (560) adapted for fixing to the upper surface (41) of said flooring (4),
which body (51) includes locking means (510) capable of being maneuvered between two positions:
an unlocking position, adapted to allow the translation of said body (51) relative to said evacuation duct, and
a locking position, adapted to prevent the translation of said body (51) relative to said evacuation duct,
which head (56) includes operating means (561), adapted to the operation of said locking means (510) between said two positions.

10. Animal housing enclosure (1) comprising a slatted floor (2) receiving a flooring system (3) according to claim 1.

11. Method of installing a flooring system (3) according to claim 1, which method comprises the following steps:
a step of laying the flooring (4) so as to cover the slatted floor (2) and such that the slots (45) of said flooring (4) are in fluidic communication with at least one opening (20) of said slatted floor (2) to form an evacuation duct,
a step of inserting said fixing device (5) into said evacuation duct, with its locking means (510) in the unlocked position, so as to sandwich said flooring (4) between the head (56) and the slatted floor (2), and
a step of maneuvering said locking means (510) of the fixing device (5) from said unlocking position to said locking position.

12. Flooring system (3) according to claim 2, wherein the width dimension of said fixing means (560) is less than the width dimension of said longitudinal groove (43).

13. Flooring system (3) according to claim 2, wherein the longitudinal grooves (43) extend perpendicularly with respect to said slots (45).
